(19) United States
(12) Patent Application Publication
(10) Pub. No.: US 2012/0097409 A1
(43) Pub. Date: Apr. 26, 2012

(54) POWER TOOL

(75) Inventors: Rainer ONTL, Landsberg am Lech (DE); Christoph Dieing, Isny (DE); Ferdinand Kristen, Gilching (DE)

(73) Assignee: Hilti Aktiengesellschaft, Schaan (LI)

(21) Appl. No.: 13/279,051

(22) Filed: Oct. 21, 2011

(30) Foreign Application Priority Data
Oct. 22, 2010 (DE) 10 2010 042 809.4

(51) Int. Cl. B23B 47/14; B23B 45/16

(52) U.S. Cl. 173/122

(57) ABSTRACT

A power tool is disclosed. The power tool has a pneumatic striking mechanism, which has a striking device that acts percussively along a working axis. A motor serves as the drive. A gear mechanism has a driving gear wheel and a driven gear wheel, where the driving gear wheel meshes with the driven gear wheel and at least the axis of rotation of the driven gear wheel is inclined to the working axis. The driving gear wheel is fabricated of metal and the driven gear wheel is fabricated of a carbon-fiber reinforced plastic.

This application claims the priority of German Patent Document No. 10 2010 042 809.4, filed Oct. 22, 2010, the disclosure of which is expressly incorporated by reference herein.

### BACKGROUND AND SUMMARY OF THE INVENTION

The present invention relates to a power tool, in particular a hand-operated rotary chiseling power tool.

In electric hammer drills, a pneumatic striking mechanism and a rotary driver are typically driven by a common electric motor. An exciter piston that is axially moved periodically by the electric motor drives an impacting piston via a pneumatic spring. The impacts executed by the impacting piston are transmitted directly or indirectly to a drill bit.

The rotary driver is connected to the electric motor via a connecting rod and a gear mechanism. The transmission of power to the drill bit typically takes place in a tool receptacle with locking elements, which engage in corresponding grooves on the drill bit. The axial impacts of the drill bit are transmitted by the mechanical coupling of the rotary driver to the electric motor. The bearings of the electric motor and the gear mechanism must be designed for the stress.

A power tool according to the invention has a pneumatic striking mechanism, which has a striking device that acts percussively along a working axis. A motor serves as the drive. A gear mechanism has a driving gear wheel and a driven gear wheel, wherein the driving gear wheel meshes with the driven gear wheel and at least the axis of rotation of the driven gear wheel is inclined to the working axis. The driving gear wheel is fabricated of metal and the driven gear wheel is fabricated of a carbon-fiber reinforced plastic.

The power flow in the gear mechanism will be described starting with the motor. The driving gear wheel is closer to the motor in the power path than the driven gear wheel.

The combination of a carbon-fiber reinforced plastic, especially preferably carbon-fiber reinforced thermoplastics, with a steel, especially preferably with a cooper admixture, has proven to be as lastingly resilient as two gear wheels made of steel with the additional advantage that radial impacts are damped. This reduces the stress to the motor.

A combination of two meshing plastic gear wheels fails under continuous load even if these are reinforced with glass fibers. The high torques to be transmitted can also not be balanced out by teeth that have a wider design. A combination of a gear wheel made of glass-fiber reinforced plastic and a gear wheel made of steel also does not provide satisfactory results. Surprisingly, the steel gear wheel fatigues in this case. The change to using carbon fibers for a gear wheel and metal for the other gear wheel produces a sufficiently resilient combination.

The gear wheels should be fabricated with a high degree of precision, i.e., smaller tolerance. Deviations in the dimensions of the teeth produce a higher wear and frictional losses. As a result, thermosetting plastics first appear to be suitable because of normally lower manufacturing tolerances. Under continuous load, a gear wheel made of polyamide, a thermoplastic, was surprising despite greater tolerances with a higher stability under load.

One embodiment provides for the power tool to have a rotary driver for rotating a tool around the working axis and the driven gear wheel made of the carbon-fiber reinforced plastic to be coupled in a power flow path between the motor and rotary driver.

One embodiment provides that the carbon fibers are aligned along a radial direction of the gear wheel. This produces especially good damping properties. The carbon fibers may be aligned radially or spirally to the axis of rotation of the gear wheel.

One embodiment provides that an outside diameter of the driven gear wheel is at least three times larger than a diameter of a shaft on which the driven gear wheel is mounted. The shaft is preferably made of steel. So that a significant level of damping may be achieved, it has been proven that the gear wheel should be considerably larger than the steel core formed by the shaft.

The axis of rotation of the driven gear wheel is inclined preferably between 70 degrees and 110 degrees to the working axis.

The following description explains the invention on the basis of exemplary embodiments and figures.

### BRIEF DESCRIPTION OF THE DRAWINGS

FIG. 1 illustrates an embodiment of a hammer drill in accordance with the principles of the present invention; and

FIGS. 2, 3 and 4 are different views of a gear wheel in accordance with the principles of the present invention.

### DETAILED DESCRIPTION OF THE DRAWINGS

Unless otherwise indicated, the same or functionally equivalent elements are identified by the same reference numbers in the figures.

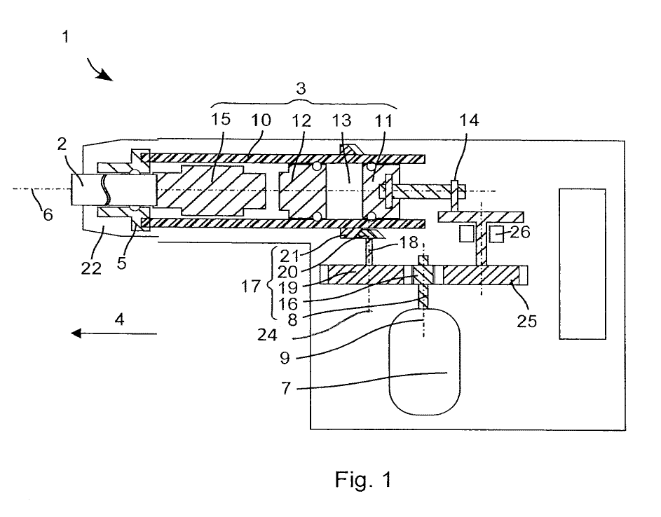

FIG. 1 schematically shows a hammer drill 1 with an inserted drill bit 2. A pneumatic striking mechanism 3 periodically strikes the drill bit 2 along an impact direction 4. In the process, a rotary driver 5 continuously rotates the drill bit 2 around its working axis 6. With the combined percussive and rotary motion, the drill bit 2 chisels circular boreholes in mineral materials.

The hammer drill 1 is driven by an electric motor 7, which drives both the pneumatic striking mechanism 3 as well as the rotary driver 5. Power supply to the electric motor 7 may be based on the power supply network or be accomplished using batteries. The high-power electric motor 7 is arranged with its shaft 8 angled, for example perpendicularly, to the pneumatic striking mechanism 3 and the working axis 6. An axis of rotation 9 of the electric motor 7 and the working axis 6 are arranged correspondingly inclined to each other. The electric motor 7 is, for example, an electrically commutated motor, such as a reluctance motor.

The pneumatic striking mechanism 3 depicted as an example includes a guide tube 10, in which an exciter piston 11 and an impacting piston 12 are mounted to slide. The exciter piston 11 and the impacting piston 12 enclose a pneumatic chamber 13 between each other. The exciter piston 11 is coupled via an eccentric 14 to the electric motor 7, whereby the exciter piston 11 is forced into a periodic movement along a working axis 6 of the guide tube 10. The impacting piston 12 follows the movement of the exciter piston 11 excited by the periodically compressed and decompressed pneumatic chamber 13, which acts as a pneumatic spring. The impacting piston 12 impacts an intermediate striking device 15 in the impact direction 4, which transmits the impact to the drill bit 2 adjacent to the intermediate striking device 15.

There is an output pinion 16 at one end of the shaft 8 of the electric motor 7. A gear mechanism 17 couples the output pinion 16 to the rotary driver 5. The depicted gear mechanism 17 has a gear shaft 18, which is arranged parallel to the shaft 8 of the electric motor 7. A first gear wheel 19 on the gear shaft 18 meshes with the output pinion 16 of the electric motor 7. A second gear wheel 20 is arranged on the gear shaft 18, and this gear wheel meshes, for example, with a gear ring 21. The gear ring 21 is connected in a rotationally fixed manner to the guide tube 10, which is rotated around the working axis 6 by the electric motor 7 and the gear mechanism 17. The second gear wheel 20 and the gear ring 21 may be configured as bevel gears, for example. The rotary driver 5 is coupled, for example, on the rotating guide tube 10 in the tool receptacle 22. The rotary driver 5 has a hollow sleeve, for example, into which the drill bit 2 may be inserted. Elements projecting into the hollow space of the sleeve, e.g., pins, engage in grooves of the drill bit 2. As an alternative to a rotatable guide tube 10, the gear mechanism 17 may be coupled to the rotary driver 5 in the tool receptacle 22 via a gear rod.

Mechanical vibrations of the drill bit 2 are induced in the power tool 1 via the tool receptacle 22 and the rotary driver 5. The force transmission path with the gear mechanism 17 may transmit the vibrations to the shaft 8 of the motor 7 though meshing gear wheels, which are arranged offset from one another along the working axis 6. A damping takes place through the use of gear wheels made of a thermoplastic containing carbon, which mesh with a gear wheel made of metal, preferably steel. In this case, the metal gear wheel is arranged on the drive side, i.e., in the drive train towards the motor 7, and the gear wheel made of fiber composite is arranged on the output side.

In the depicted example, the output pinion 16 of the motor 7 is made of steel and the frontal, first gear wheel 19 meshing with the output pinion 16 is made of a thermoplastic containing carbon fiber. The axis of rotation 24 of the first gear wheel 19 is perpendicular to the working axis 6. The output pinion 16 of the electric motor 7 is preferably made of metal; along with steel, alloys containing copper are especially suited, e.g., with a copper percentage of more than 50%.

The second gear wheel 20 on the shaft 18 may preferably be made of steel.

One branch of the gear mechanism 17 for coupling the eccentric 14 to the motor 7 is preferably made completely of steel gear wheels. These are able to handle the high repercussions emanating from the striking mechanism 3 on a sustained basis. In one embodiment, the gear wheel 25 meshing with the output pinion 16 of the motor 7 may be fabricated of a thermoplastic containing carbon fiber. The shaft of the eccentric 14 is fed through one or more bearings 26, which absorb a large portion of the radial impacts. The vibrations relayed to the output pinion 16 may be sufficiently damped so that the gear wheel 25 made of plastic is able to handle the forces occurring.

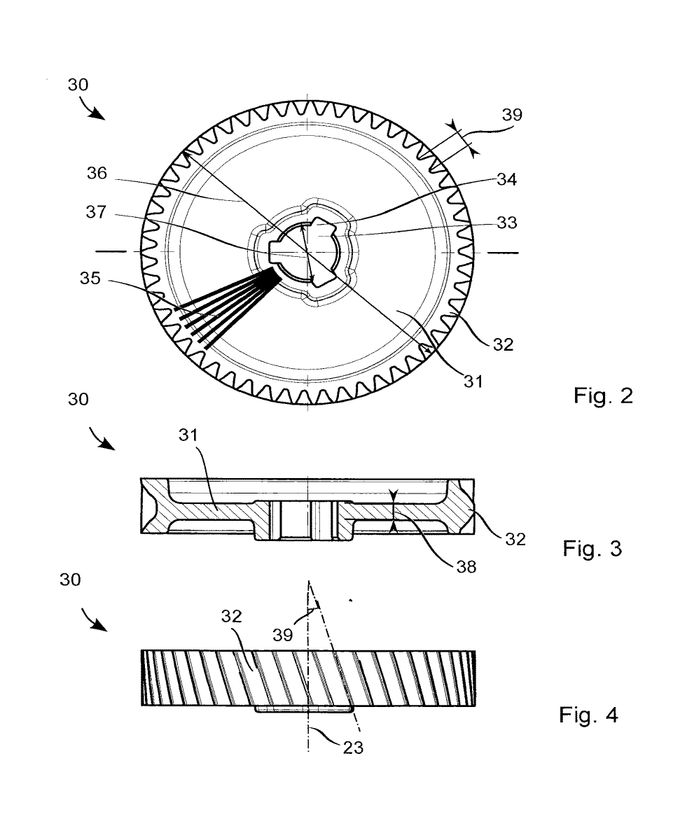

FIG. 2, FIG. 3, and FIG. 4 show an exemplary structure of a damping gear wheel 30 made of a carbon-fiber reinforced thermoplastic in a top view, cross-section, and side view, respectively. The damping gear wheel 30 may be used, for example, as the first gear wheel 19. The gear wheel 30 has a discoid base body 31 made of a carbon-fiber reinforced thermoplastic. The thermoplastic is preferably selected from the class of polyamides. It would not be possible to obtain the desired properties with other fibers such as glass fibers.

Teeth 32 are formed in the periphery of the base body. The teeth 32 may be inclined with respect to the axis of rotation 23 by an angle of inclination 39 of between 5 degrees and 25 degrees, e.g., 17 degrees. The output pinion 16 is configured with the same angle of inclination for a more uniform transmission of the force of the teeth meshing with one another. The damping gear wheel 30 has a continuous hub opening 33 in the center, which has several radially running grooves 34 that deviate from a circular shape for an improved transmission of torque. The preferably steel gear shaft 18 is pressed into the hub opening 33. Wings on the gear shaft 18 engage in the grooves 34.

The structure of the discoid base body 31 is designed with respect to a decoupling effect in the impact direction 4. The carbon fibers preferably run solely in the radial direction, i.e., from the hub opening 33 in a straight line to the periphery with the teeth 32, as indicated in FIG. 2 by individual carbon fibers 35. No carbon fibers 35 that run transversely, e.g., in a circumference around the axis of rotation 23, are arranged with the radial radially carbon fibers 35. The lack of interconnectedness surprisingly proved to be advantageous in damping the radial impacts initiated by the pneumatic striking mechanism 3 via the gear shaft 18 in an especially efficient manner. Although a carbon fiber along its alignment is able to transmit the greatest forces, the structure appears to be inefficient for a transmission of the impacts in an advantageous manner. It is presumed that the shock wave is able to flow outwards in the matrix made of thermoplastic.

The geometry of the base body 31 likewise shows possibilities of decoupling the output pinion 16 from the impacts. The damping gear wheel 30 preferably has a diameter 36, which is at least three times as large as an inside diameter 37 of the hub opening 33 or the gear shaft 18. The diameter 36 is defined as the tip diameter, i.e., a diameter of a circle circumscribing the damping gear wheel 30. At the same time, the discoid base body 31 preferably has a thickness 38 which is between 4% and 8% of the diameter 36. The discoid base body 31 here shows a sufficient softness along the axis 23, which makes possible an excitation by the shock waves from the impacts. The radially initiated impacts may thus run to some extent in the axial direction. Even though the meshing gear wheels are shifted slightly against each other in the process, this however proved to be more beneficial than radial impacts on the shaft 8 of the motor 7.

The number of teeth 32 along the circumference of the first gear wheel 30 is advantageously limited. A ratio of the diameter 36 of the first gear wheel 30 to its number of teeth 32 lies in a range of 1.0 cm/per tooth to 1.25 cm/per tooth. The teeth 32 have a relatively large base area 39, whereby the impacts are distributed to a larger segment of the base body 31.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A power tool, comprising:
a linear drive, wherein the linear drive defines a working axis;
a rotary driver;
a motor; and
a gear mechanism, wherein the linear drive and the rotary driver are drivable by the motor via the gear mechanism, and wherein the gear mechanism includes:
a driving gear wheel; and
a driven gear wheel;
wherein the driving gear wheel meshes with the driven gear wheel;
wherein an axis of rotation of the driven gear wheel is inclined to the working axis;
and wherein the driving gear wheel is a metal and the driven gear wheel is a carbon-fiber reinforced plastic.

2. The power tool according to claim 1, wherein a shaft of the motor is inclined to the working axis.

3. The power tool according to claim 1, wherein the axis of rotation of the driven gear wheel is perpendicular to the working axis.

4. The power tool according to claim 2, wherein the shaft of the motor is perpendicular to the working axis.

5. The power tool according to claim 1, wherein carbon fibers of the carbon-fiber reinforced plastic are aligned along a radial direction of the driven gear wheel.

6. The power tool according to claim 5, wherein the carbon fibers are aligned solely parallel to the radial direction of the driven gear wheel.

7. The power tool according to claim 1, wherein an outside diameter of the driven gear wheel is at least three times larger than a diameter of a shaft on which the driven gear wheel is mounted.

8. The power tool according to claim 1, wherein the axis of rotation of the driven gear wheel is inclined between 70 degrees and 110 degrees to the working axis.

9. The power tool according to claim 1, wherein the metal of the driving gear is an alloy containing copper.

10. The power tool according to claim 1, wherein the linear drive includes a pneumatic striking mechanism and a striking device.
